(19) United States
(12) Patent Application Publication
(10) Pub. No.: US 2006/0260743 A1
(43) Pub. Date: Nov. 23, 2006

(54) Method of preparing prime labels and intermediate web assemblies produced therewith

(75) Inventor: Jesse D. Crum, St. Fort Scott, KS (US)

Correspondence Address: WARD/KRAFT, INC., 2401 COOPER STREET, P. O. BOX 938, FT. SCOTT, KS, 66701, US

(73) Assignee: Ward/Kraft

(21) Appl. No.: 11/135,481

(22) Filed: May 23, 2005

(51) Int. Cl. B32B 37/00

(52) U.S. Cl. 156/291; 156/299

(57) ABSTRACT

The present invention is in the field of identifiers such as tags and labels, which may be used in advertising, marketing, communications or for designating a source of a particular product or service and relates to a method of manufacturing prime label intermediates in an unique continuous web format. The subject of this application specifically includes pressure sensitive laminates that are produced in a sheet to roll type of format and provided in one or more intermediate configurations to an end user. A series of sheets are pre-printed, then slit or cut to size to create individual ribbons or label segments, with each segment having prime label areas. The prime label segments are then applied to a continuously advancing web so as to create a web having a series of discontinuous label segments disposed thereon. More particularly, the pressure sensitive laminates of the instant application can be used to create individual, prime labels having a high or photo quality resolution level, of more than about 150 lines per inch and preferably about about 300 lines per inch.

### CROSS-REFERENCES TO RELATED APPLICATIONS

None.

### FIELD OF THE INVENTION

The present invention is in the field of manufacturing intermediate web assemblies to produce identifiers such as tags and labels that may be used in advertising, marketing, communications or for designating a source of a particular product or service. The subject of this application specifically includes a method of manufacturing prime labels from an intermediate pressure sensitive web construction and the article produced from that manufacture. The labels of the present invention are produced in part, initially from a pre-imaged or printed sheet and then converted or merged to a roll type of format and provided in one or more intermediate configurations to an end user. The sheets are printed with high quality graphics or images which are then slit or cut to size to form ribbons or label segments for the prime label application and then are converted to or merged with a continuously advancing web to create a continuous roll format. More particularly, the pressure sensitive laminates of the instant application can be used to create individual, prime labels having a high or photo quality resolution level that is about 300 lines per inch or approximately 2500 to 3500 dots per inch.

### BACKGROUND OF THE INVENTION

Today, there are wide varieties of product offerings available that serve multiple purposes and functions, including product offerings that are used in fulfilling needs in the prime label market. Conventional processes that are used today in creating prime labels are typically based on a continuous web technology using flexographic presses. The process includes the feeding of a continuous web of material, such as a preformed web of pressure sensitive laminate which normally consists of a top ply having a layer of adhesive on its underside that is covered by a release liner to form the laminate assembly through the press. The web is then processed through a press, typically a flexographic press, and an image is applied to the web by various stations. The web may then be collected, die-cut and the individual labels removed and applied.

Flexography is commonly used today for the printing of decorative items including the rendering of packaging and employs a series of plates and one or more stations, containing inks, to apply colored images to the web as the web traverses the press. Through improvements in ink qualities and other modifications and enhancements in the technology, the image quality in flexographic presses and resulting products has improved to about 150 lines per inch.

For a point of reference, typically, screens that have rulings of between 60 to 100 lines per inch are normally used to make halftone printed images for newspapers. Screens with about 120 to 150 lines per inch are commonly used today to produce images for magazines and commercial printing. Such screens are regularly produced by electronic dot generation.

Electronic dot generation is normally performed by computers that use unique screening algorithms in cooperation with electronic scanners and image setters to produce halftone images that are to be subsequently used to render an image. The pixels of digitized images are first assembled into dots that are then used to form shapes, sizes, rulings, etc. which create the ultimate image produced on the substrate.

While flexographic technology or flexography is desirable for use in such printing due to the economies that can be achieved when compared with other types of printing processes, such as lithography, there are a number of drawbacks in utilizing this process for certain applications. Initially, the quality is limited, despite improvements in the technology to about 150 lines per inch. This can make some complicated graphics appear “grainy” or other images, such as those that use flesh tones or deep or rich colors, look faded or “washed out”. The effects of this level of image resolution can detract from the product appearance which may diminish the value of the technology and the products produced particularly for the prime label market. With increasing sophistication of consumers, as well as technology and expectations from each, such effects may be undesirable to potential end users.

Flexography also suffers from other drawbacks, such as the time involved in preparing a job to run or “make ready” as it may otherwise be known. That is, the steps that are used to prepare the flexography equipment for running a particular job or order. This make ready includes such activity as the preparation of multiple plates to produce the image at each station, mixing inks, calibration and alignment of the images between stations and the like. Operation of the flexography presses may also include multiple operators which can add to manufacturing costs. In addition, waste can also be a problem with such conventional printing technologies in that a number of feet, yards or meters of web material must be processed through the press in order to have the colors reach a predetermined threshold and to ensure appropriate registry of the stations as they are printing the images on the web. The amount of material wasted can be several times the length of the press or up to several hundred feet of material. The use of such volumes of materials obviously increases the cost of the operation. Thus, due to the make ready and waste factors, the production of products, such as prime labels, using flexography may then be limited to serving only certain market segments, namely large market segments. Markets that are applicable for this technology segment are generally believed to be those orders for large quantities of several hundred thousand or millions of pieces, which potentially leaves the smaller label market, e.g. 100 to 1,000,000 labels, unfulfilled or at least not adequately served by currently available technologies due to cost and materials thresholds.

Another drawback believed to be associated with flexographic technologies is that the technology cannot provide any variability in the product, including such basic functionality as sequential numbering, addressing or adding promotional text in connection with a seasonal advertisement or other offering without the addition of further processing stations. If such features are required by an end user or customer, such as with product date or coding, this function generally cannot be performed by flexographic presses without the inclusion of additional stations and instead typically must occur through an off line operation, such as ink jetting, often after the label has been applied to the container or carton. Alternatively, the ink jetting may be performed directly on the container as part of a separate operation.

Flexographic presses normally have a number of pre-determined stations, for example a four color press may have only four stations that can be used to treat or process the web. Thus, if other stations are to be added, such as a numbering head, the manufacturer likely then has to reduce the number of colors that can be added to the web as one station has been surrendered for the numbering head.

Flexographic technology also limits the ability to add personalization to products produced on such presses. This may be particularly desirable in certain market segments such prime label products on consumer package goods (“CPG”) which may further enhance the product or service offering by making the product more attractive to prospective purchasers, thereby increasing the appeal to the consumer of the product or service.

Identifiers such as labels or tags may also be readily rendered using desktop equipment. While the resolution may be slightly improved when compared with conventional flexographic technology, speeds of application are significantly reduced as the images are processed in a sheet wise fashion on desktop equipment resulting in only a few sheets per minute as opposed to hundreds of feet per minute that are capable of being processed by flexographic equipment. That is, the desktop unit may only handle and print one sheet at a time before the next sheet is advanced for printing or imaging when compared with a conventional web fed process. Thus, in using such a desktop process one may only be able to render a handful of sheets per minute as opposed to a flexography operation that may process several hundred feet per minute. Use of desktop processes is thus not likely efficient in trying to generate hundreds and certainly not thousands of labels, but may be useful in creating a few dozen labels for very small applications such as a small home or small office environment.

What is needed therefore is a process by which high quality graphics for prime label applications, in excess of about 150 lines per inch, can be produced in an efficient and cost effective manner, such as in a continuous process operating at greater than fifty feet per minute. Moreover, a process which can add substantial variability to the product as well as other features, such as embossments, over laminates, variable printing or imaging and the like, would greatly expand the penetration of this form of business communication in the marketplace. The present invention seeks to provide a prime label intermediate having a quality of about 150 or more lines per inch and preferably more than 300 lines per inch, which is approximately equal to about 2500 to 3500 dots per inch (“DPI”) in order to create a high quality image that is intended to be aesthetically appealing to the consumer.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Surprisingly, it has been discovered that there is no readily available process or system by which a manufacturer can create high quality prime labels having significantly improved graphic resolution that is greater than about 150 lines per inch, preferably greater than about 200 lines per inch and still more preferably about 300 lines per inch, in an efficient and cost effective manner. The development of the present system, process and the creation of the unique intermediate web assembly described in this invention permit the servicing of a particular niche market segment for prime labels, that of approximately 1000 to 1,000,000 prime labels. While the foregoing market size or segment is a target area of the present invention, it should be appreciated that the invention may be practiced and used to fulfill larger order quantities, such as those of a million labels or more.

The pressure sensitive intermediate of the present invention is created through a unique sheet to roll process which provides savings when compared with conventional flexography process, specifically through reduced make ready time and generation of waste material. The present invention uses previously prepared individually created sheets, or segments, that have imaging or printing already applied to the sheets, e.g. graphical depictions, before the sheets are provided to the manufacturing press. The sheets may be applied in either in a substantially edge-to-edge configuration or alternatively, provided in regularly occurring increments depending on the needs of the particular application to be serviced. In addition, the product produced in connection with the present process described in the instant application is also not limited in functionality as a number of materials, operations and options may be used in creating a relatively dynamic product. Such additional processes may include variable printing, embossments, coatings, over laminates and the like.

By preparing the intermediate prime label assembly in the manner described herein, the intermediate web can be processed continuously at speeds of greater than 50 feet per minute, preferably between about 75-150 feet per minute and still more preferably at speeds of about 200 feet per minute or greater.

In one exemplary embodiment, a method of producing a continuous label laminate assembly is described and includes the steps of initially advancing a continuous web. The web has first and second longitudinally extending sides, first and second faces and a release coating that is provided on at least a portion of the first face. Next, an adhesive is applied on the first face over the release coating.

In order to create the portion of the web that will be used as the prime label products, a plurality of discrete label ribbons intermediates are produced, typically in an off line high quality imaging or rendering unit. Each of the intermediates has at least one prime label portion printed thereon with the printing or imaging having a resolution of at least about 150 lines per inch. Next, each of the label ribbon intermediates is sequentially placed on the continuous web over the adhesive through the use of a mechanical placer and cooperating drum that are operated in sequence with the advancing web. The continuous web in a machine direction with the plurality of discrete label ribbon intermediates adhered to the surface by the adhesive. Finally, the continuous web with the plurality of discrete label ribbon intermediates is collected in a roll.

In a still further exemplary embodiment, another method of producing a continuous prime label laminate assembly is described and includes the steps of, initially advancing a continuous web, the web have first and second longitudinally extending sides, first and second faces and a release coating provided on at least a portion of the first face. Next, an adhesive is applied to the first face over the release coating.

Still continuing with a discussion of the present invention, a plurality of discrete label ribbons intermediates are placed substantially in an end to end arrangement on the web with each of the intermediates having printing or imaging thereon in an area of a prime label portion with the printing having a resolution of at least about 150 lines per inch. Each of the discrete label intermediates is then cut, such as with a die cutting step to form individual prime label portions. A matrix is created by the die cutting and is then removed from around each of the prime label portions, then the web with the die cut out portions of the prime labels is collected in a roll format.

In a yet still further embodiment, another exemplary method of creating a prime label intermediate pressure sensitive web is described and includes the steps of initially providing a continuous web of material having first and second faces and first and second longitudinally extending sides. The continuous web is advanced in a machine direction to a first station at least at a machine speed of at least about 50 feet per minute. Then a pattern of adhesive is applied in the machine direction to the first face of the continuous web. The adhesive will be applied over a release coating which will have been applied to the web in a previous step or alternatively, the web was supplied with a release coating already disposed on the web.

Continuing with a discussion of the presently described embodiment, a series of previously prepared prime label segments, is prepared with each segment having at least one prime label intermediate printed with a graphical depiction. Each of the prime label segments is placed, sequentially, over the pattern of adhesive in the machine direction such that each of the prime label segments are positioned in at least a substantial edge to edge configuration. The continuous web with the prime label segments disposed thereon is then advanced in a machine direction to a collection point to create a continuous web having a series of repeating prime label segments.

Each of the foregoing exemplary methods may be practiced using additional processing steps. For example, after the label segments have been placed on the web, the segments or intermediates can be further imprinted or imaged with personalized or variable information. In addition, the prime label portions may be connected to one another in a long string to help retain the prime labels on the web, after the matrix has been removed. Alternatively, the string may be applied to the matrix area and be stripped away with the matrix.

The web may also undergo additional treatment steps after the prime label segments have been added to the web. These treatments may include the applications of coatings, films, embossments, blown on labels and combinations thereof.

The uniqueness of the invention allows for the creation of a variety of high quality prime labels having graphical depictions of greater than about 150 lines per inch and likely more than about 200 lines per inch.

The production of the prime label intermediate web assembly prepared in accordance with the present invention creates an intermediate web assembly that has intermittent laminations. That is, portions of the prime label segments are adhered to the web and smaller portions, such as the edges, may be free of adherence due to a slight overlap between successive prime labels segments disposed on the web. The overlap is preferably less than an inch, more preferably less than one half of one inch and still more preferably about 1/32″ and yet still more preferably about 1/64″. The overlap may be created to facilitate the placing of sheets on the web and accommodates slight changes in timing that may occur due to web or placer mechanism speed. It should be understood that it may not be necessary to create an overlap and the sheets may be laid edge to edge or alternatively the sheets may be spaced from one another along the web. In this latter configuration, the adhesive, if exposed may be deadened by application of radiation, over coatings or the like. The label segments may be applied to the web in regular or irregular patterns.

The prime label segments or sheets are pre-imaged or printed prior to being applied to the carrier web. In this manner, a number of permutations can be made to the prime label and thus the labels are not limited by equipment constraints as may be found in connection with other equipment used in preparing prime labels. The prime label segments or sheets can be provided in a number of shapes, and may be produced with coatings, numbering, embossments and pseudo embossments, as described in commonly assigned, co-pending application Ser. No. 10/980,347 filed Nov. 3, 2004 the disclosure of which including that found in the claims is incorporated herein by reference.

In addition to various surface treatments (e.g. printing, coating, etc.) that may be applied to the prime label sheets or segment, the prime labels may be provided in a number of shaped configurations, (e.g. quadrate, non-quadrate, geometric, animate, inanimate, alpha, numeric and combinations thereof). The prime label segments may also be imaged in line with variable information, such as numbering, personalization, coding and the like.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a top or surface view of the prime label intermediate web assembly of the present invention showing a series of label segments or ribbons with graphical depictions that vary from one segment to the next;

FIG. 2 provides a block diagram representing an exemplary method of carrying out the present invention;

FIG. 3 illustrates a further block diagram that is used to carry out a further exemplary process of the present invention;

FIG. 4 shows a still further block diagram used to represent a further method for carrying out the process associated with the present invention;

FIG. 5 provides a block diagram setting forth exemplary steps that may be used in carrying out the presently described invention to create the prime label intermediates;

FIG. 6 depicts a schematic of the apparatus that is used to carry out the invention; and

FIG. 7 illustrates the continuous web assembly of the present invention having a number of individual prime label intermediates with the matrix stripped away and connected to one another by a supporting strip or string.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

The term “prime label” as used herein refers to a label or other identification piece that may be used interchangeably with labels, such as tags, typically having a pattern of adhesive disposed on one side of a substrate and one or more graphical illustrations or depictions on the opposite side. Some level of textual messaging may also be provided on the face of the label. The adhesive is typically a pressure sensitive adhesive but may also include activatable adhesives such as thermally or moisture sensitive materials. However, it should be understood that all prime labels need not be provided with an adhesive.

Prime labels are further distinguished from other labels in the art in that such labels are known as having a high level of quality or value. The term prime label is often used to describe a type of label that is the highest grade marketed in a particular industry. Prime labels find application in a number of exemplary areas but have found wide range acceptance particularly in the area of consumer packaged goods (“CPG”) and other products for which the prime label is an effective means for communicating a specific message or enhancing the image of the manufacturer or distributor. Prime labels are also used for business communications in that they can convey certain desirable criteria, image, brand recognition or information and can be used independently of a product, such as in connection with advertising a service opportunity or offering, or with other activities or undertakings, such as for example non-profit organizations.

Prime labels, particularly prime labels prepared in accordance with the present invention, may also contain printed messages, including personalized and/or variable information in addition to the graphical displays. The printed messages can be fixed or static, as will be explained herein, may be personalized or sequentially numbered or provided with other unique or special identifiers.

The term “patterns” as used herein refers to strips, lines, shapes, spots, dots, elements and discontinuous segments, as well as regular and irregular placement of such items. Patterns may also refer to combinations of the above-mentioned items such that one pattern may be a continuous strip; another, segmented elements; and a still further an irregular placement of elements or the like. Any combination of patterns is possible depending on the need or application of the manufacturer or the end user. In addition, the pattern can be prepared in order to accommodate a particular theme, season, event, trade dress, graphics, alpha and numeric characters, and the like. Patterns are used in connection with the present invention to describe the placement of the label segments or ribbons applied to the web or individual prime labels positioned on the web in a particular pattern or arrangement. Pattern as defined herein also is used in connection with the adhesive that is applied to the continuous web.

As used herein the term “business communication piece or document” is used to refer to a substrate that, either alone or in combination with other documents can convey a particular message, image or provide information about a particular product or service that is available from the provider of such pieces or documents. Business communication documents or pieces can include advertising, sales and marketing collateral and such other items used to convey information on written or imaged form sheets, brochures, presentation folders, informational sheets and combinations thereof.

The term “personalized information” refers to information that is printed or imaged onto a substrate which is generally variable or unique and which may change from document to document or segment to segment so as to create a customized message or communication for each recipient. Examples of personalized information may include for example names, addresses, descriptions, plans, coding, numbering, promotional text, etc. that may have been acquired from the intended recipient through surveys, questionnaires or answers given to various inquiries generated in response to a request for goods or services.

The term “static or fixed” information refers to printed or imaged information that generally does not change from document to document or segment to segment and may include a general description or body of information about particular products, services, places, etc. that may be of interest to the intended recipient and represents a standard message that the manufacturing or supplier wishes to convey to an end user or customer of the offering.

The term “intermediate” as used herein refers to a product that undergoes one or more processing steps prior to the intermediate reaching a final condition, that of being ready for end use or application. The additional processing steps may include printing, imaging, folding, sealing, separating, cutting, perforating, scoring, adhering and the like. Typically, a product such as with the present invention is provided in an intermediate condition so that a user can add or manipulate the intermediate to create the final or desired end product, such as applying the prime label to a container, carton or the like. Thus, in accordance with the present invention, the intermediate segment for example, could be subject to die cutting, additional printing, such as through ink jetting, over laminating, coating, embossment, and then applied to a container, carton, consumer package good or the like.

The term “sheets” or “segments” as used herein refers to sheets, segments, ribbons, strips, pieces, parts, sections, subdivisions and combinations thereof. The sheet or segment provided in this specification can be an entire sheet such as 8½″×11″, 11″×14″, 19″×25″ and other known sheet sizes or may be segments, divisions, strips, etc. of such sheets. For example, a 19″×25 sheet may produced with five rows of labels, with each row having six labels, with each label having dimensions of approximately 3″×4″. In this example, each row for instance may comprise an individual segment or sheet that may be used in practicing the present invention. It should however be understood that the invention is not to be so limited to the foregoing configuration and that individual pieces or elements may be used in connection with this process to produce the intermediate assembly provided herein.

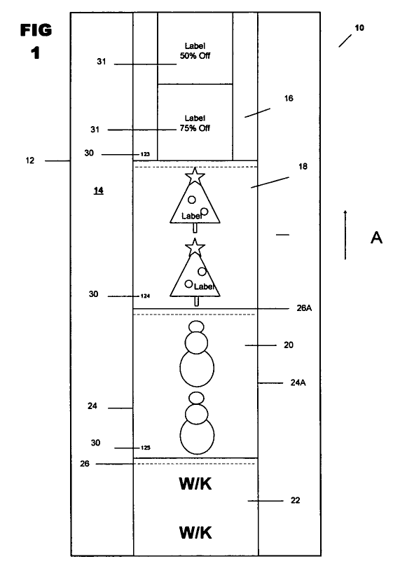

Turning now to drawings of the present invention and initially to FIG. 1. The pressure sensitive prime label intermediate web assembly is generally depicted by reference to the numeral 10. The intermediate assembly 10 includes a carrier web or continuous web 12 that has a first face 14 and a second face (not shown). The second face would be the underside of the carrier web. The continuous web 12 is preferably selected from a highly calendared, cellulosic based stock having a release coating, such as silicone. The release coating is provided on the first face 14 such that when an adhesive is applied, as will be described herein, the adhesive will transfer to the back of the label segments or sheets when the individual prime label intermediates are removed from the web. This will occur as the adhesive has a greater affinity for the label segments or sheets than for the carrier web as the label segments do not have a release coating applied to the surface in contact with the adhesive.

The web assembly 10 is advanced in a machine direction, which is designated as “A”. Machine direction for the purposes of this invention is generally intended to mean the direction in which the apparatus handles the web of material and subsequently advances the web to and through each station resident on the equipment that is used to practice the invention.

As provided in FIG. 1, the web assembly is provided with a number of prime label sheets or segments, 16, 18, 20 and 22. Each label segment has first and second sides and a first and second ends. An individual label segment is identified by reference to segment 20, in which the longitudinally extending sides are designated by 24 and 24A and the first and second ends 26 and 26A. As provided in the drawing, edge 26 is shown in phantom as it is disposed beneath label segment 22. The label segments may be placed in a substantial edge to edge configuration, which may preferably result in a slight overlap of successive label segments. Thus, edge 26 is disposed beneath the edge of the successively applied direction (again referring to the machine direction “A”). It should be understood, that while an overlap may be created, the successive label segments need not overlap one another or alternatively, the label segments may be spaced from one another.

By creating a slight overlap as described above and depicted in FIG. 1, the intermediate web assembly 10 is provided in an intermittent laminated configuration, that is, not all portions of the label segments are in full adhesive contact or fully adhered to the web 10. That is, a portion of the label segments are free of attachment to the web as well as successive label segments, that is, they are not connected to one another.

FIG. 1 is also used to show that the prime label segments 16, 18, 20 and 22 each contain different indicia images and geometric configurations. In addition to generally quadrate shapes depicted in label segment 16, label segment 18 is provided with inanimate shapes, label segment 20 with another geometric pattern that is non-quadrate and label segment 22 is provided with alpha characters “WK.” Thus, each label segment may be provided with different indicia or shapes or alternatively, it should be understood that the invention can be practiced such that each label segment may be provided with identical graphical depictions.

The unique process described in the present invention also permits the label segments 16, 18, 20, etc. to be provided with sequential numbering 30 or other indicia such as variable indicia 31 which shows a possible coupon application for CPG's. This may be accomplished in one of two fashions. In a first arrangement, the label segments are individual sheets and are prepared prior to being applied to the continuous web or carrier as will be described herein. Thus each sheet, before being provided for inclusion in the process may be printed with the variable information such as with an Indigo 3050 available from HP of Palo Alto, Calif. In the second arrangement, the sheet may be imaged after it has been applied to the web such as with an ink jet printer available from Scitex of Dayton, Ohio with such imaging to include the personalization or application of variable data in line.

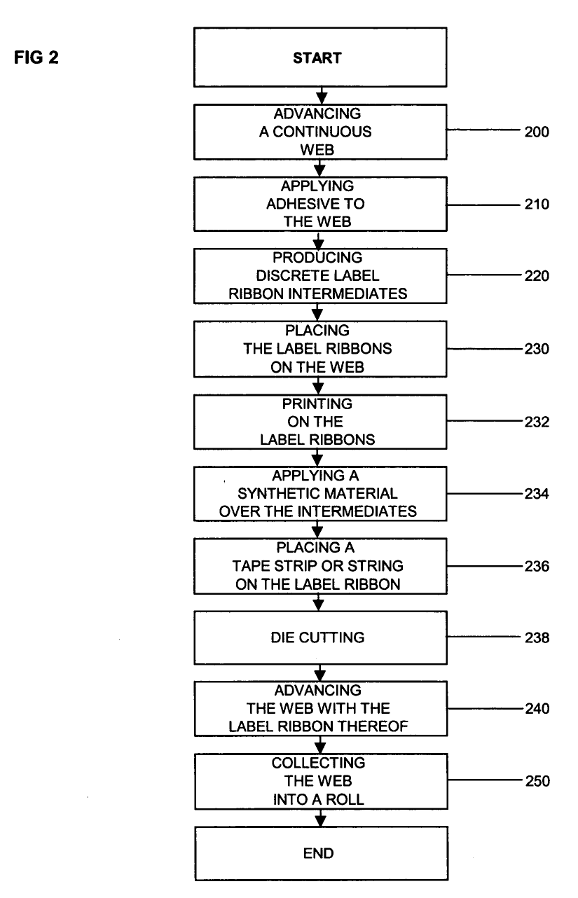

Turning now to FIG. 2 a block diagram is presented showing one exemplary process for carrying out the present invention. A continuous web at step 200 is advanced in a machine direction, the direction that the processing apparatus handles a web. The web is provided with a coating of release material that is provided between the longitudinal edges of the web. Next, a layer or pattern of adhesive is applied over the release material at step 210. The adhesive will preferably be a permanent type adhesive, but other adhesives may be used depending on the particular requirements of the job that is being produced.

A series of discrete label ribbons is prepared at step 220. The preparation of label ribbons is preferably performed in a separate operation, such as by a high quality imaging or rendering device that can produce graphical depictions at levels of at least about 150 lines per inch and preferably more than about 200 lines per inch, examples of such rendering devices include Indigo® available from Hewlett Packard Company of Palo Alto, Calif. or Karat available from KBA of Williston, Vt. The label ribbons are produced in a standard sheet configuration as mentioned above and then cut or slit to create individual ribbons that are then inserted into a placer mechanism, such as available from InLine Automation of Minneapolis, Minn. that is used to sequentially place the ribbons on the web at step 230 over the pattern of adhesive. Each of the ribbons is also provided with prime label areas, which is the area where the graphical depictions, imaging and personalization if added are provided. The prime label areas are the areas of the label segment that are ultimately removed to become the prime label on the container or the receptacle to which the label is applied.

The label ribbons at step 230 are preferably placed and applied in an edge-to-edge relationship on the web, but it should be understood that the label ribbon intermediates may be spaced from one another a predetermined distance or alternatively the ribbons may slightly overlap one another, or a combination of spacing, edge-to-edge arrangement and spacing may occur. The label ribbons may be applied in any regular or irregular pattern as may be determined by the particular use being made of the intermediate web assembly. Once the label ribbons are applied to the web, there may be a slight pressure applied to further secure the ribbons to the web or alternatively, the pressure applied through the application mechanism (placing roller contacting the label ribbon with the web) may be sufficient to adequately affix the label ribbons to the web. The web is then advanced at step 240 such as by a rewinder or other mechanism that can collect the web material into a roll or other continuous format, e.g. fan folded.

After the application of the web at step 230 and possibly simultaneously or sequentially, with the step of advancing the web with the ribbons applied thereto, a number of additional processing steps may also be accomplished as will now be described.

The label ribbons may be printed in line, which is during the creation of the intermediate laminate web at step 232. The in-line printing may add variable or personalized printing or indica directly to the prime label portions while those portions are either still resident in the ribbon segments or after die cutting. The addition of such processing equipment will not be a disadvantage to the manufacturing press like may be encountered with a conventional flexographic press. For example, with a flexographic press, the stations are principally used to apply color to the web. With the present invention, the sheets or segments can be printed in line (in addition to any pre-printing that may have occurred) and thus there is not a need to use the stations to lay down one or more colors on the web as with flexographic equipment. Thus any available stations can be used for numbering, imaging, coating, etc.

If processing step 234 is utilized, synthetic films may be applied over the top, bottom or both sides of the prime label portions and or intermediates. For example, a film having a thermosensitive adhesive coating on one side may be fed through one or more heated rollers to activate the adhesive and then the film is applied to the prime label material. In this fashion, a protective covering can be added to the prime label portions or alternatively, the prime label portions can be used in the creation of card or tag products. Other methods of adding synthetic films are also know such as laminating subsequent to applying or laying the film over the intermediate.

Processing step 236 includes the application of a strip of tape or string to the prime label portions. The intent of this application is to create a temporary binding between the prime label portions so that after the matrix is stripped away and the web is advanced, the labels are held together by the strip of material. The strip of material is then easily severed or broken upon removal of the prime labels from the web and application to the container or other receptacle. Alternatively, the string may be applied to the matrix and be stripped off with the matrix.

In all likelihood, the processing will include a step of die cutting 238 in which the excess material of the label ribbon intermediate is cut from the prime label portion so that the prime label is formed. The die cutting can be performed as part of the manufacturing of the label web intermediate, or alternatively, it can be performed at an off-line operation.

Finally, after the web has been advanced and subjected to any additional processing applications, the web is then collected at step 250 and wound onto a roll for automated label applications.

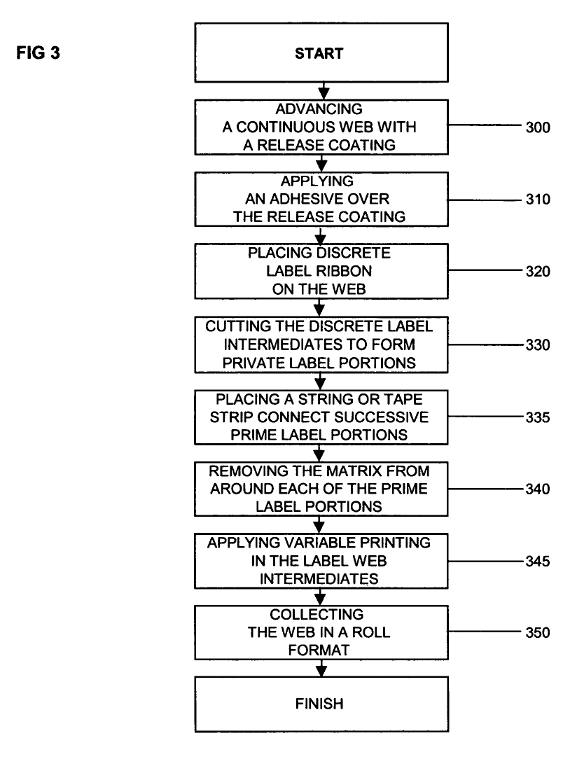

FIG. 3 represents another exemplary method in carrying out the present invention. At step 300 a web having a release coating thereon is advanced and at step 310 a pattern of adhesive is applied over the release coating. A number of discrete label segment intermediates are placed on the web at step 320 over the adhesive. The prime label intermediate segments are separate from one another, that is they are placed individually into the hopper for the placer and are dispensed separately from one another and applied in a sequential and repeating fashion to the web. The prime label intermediate segments are then die cut at step 330 to create individual prime label portions or areas which will make up the prime labels that will be used in connection with a package labeling application. By die cutting, a removable matrix is created and then removed at step 340. The web with the prime label portions is then collected at step 350 in a roll configuration or other continuous arrangement such as fan folding.

As with the previous method described above, additional processing steps are again possible in connection with the practice of this method. These may include but are not limited to the placing of a removable and frangible strip of material at step 335 which will hold the prime label to portions in alignment on the web as the web is subject to further processing or treating steps. The prime label portions may also have personalization or variable printing or imaging applied at step 345.

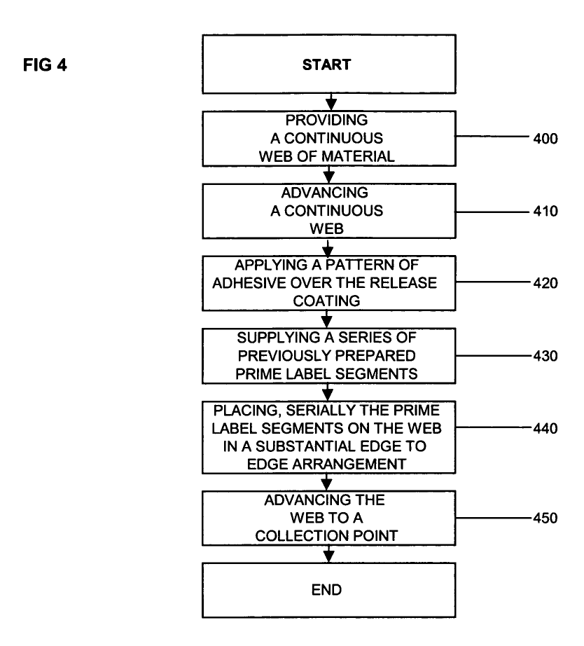

FIG. 4 sets forth a yet still further exemplary process in carrying out the present invention. This method is again commenced with the provision of a continuous web at step 400 which is advanced at step 410 to an adhesive coating station at step 420 at which a pattern of adhesive is applied over the top of the release coating on the web of material. Next, a series of previously prepared label segment intermediates having graphical depictions as well as printed information, static and personalized, of at least about 150 lines per inch is supplied at step 430. These segments are applied sequentially and serially over the adhesive at step 440 so that the segments are in a substantial edge-to-edge configuration or arrangement. The web is then advanced to a collection point at step 450. The collection point will preferably be an arrangement in which a roll is created but it should be understood that a fan folded configuration is also contemplated by the present invention.

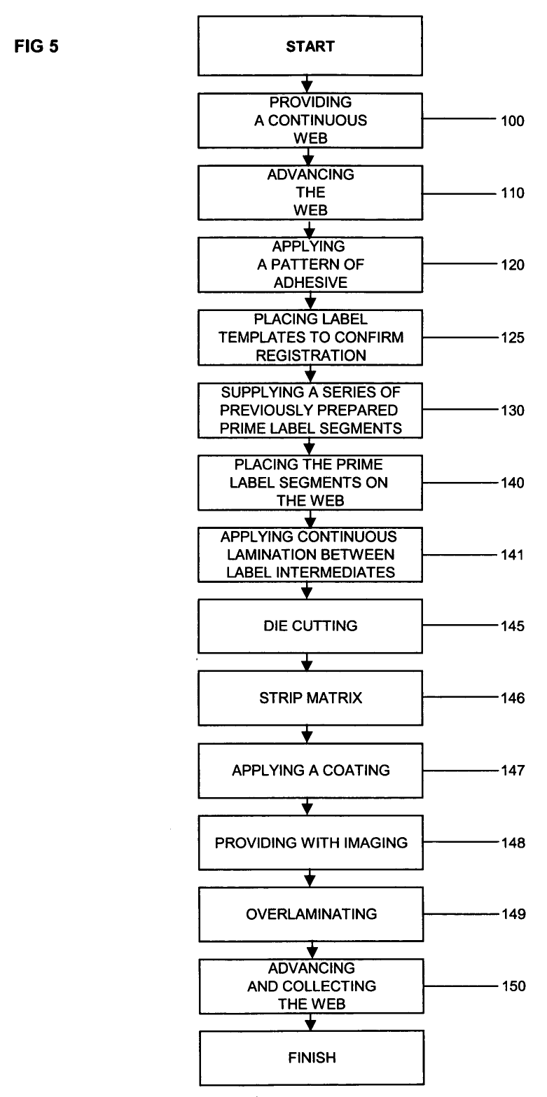

Reference is now directed to FIG. 5 in which a block diagram is provided to illustrate the steps that are utilized in carrying out the present invention. The process begins by providing a continuous web or carrier web at step 100. The carrier web as described above will have a release coating provided on the face or surface that will receive the adhesive in a subsequent step. Next, the web is advanced in a machine direction at step 110. A pattern of adhesive is applied at step 120 and the application of the adhesive is performed through the use of conventional adhesive applications devices, such as slot die applicators or other suitable equipment such as screen coater, etc. The adhesive is generally applied only in those areas where a label segment, strip or sheet will be positioned so as to avoid having adhesive exposed on the web which may hinder downstream processing of the pressure sensitive laminate web assembly. It should be appreciated however, that if adhesive is applied to the web and remains exposed after placement of the label strip or segment, that the exposed adhesive can be treated to “deaden” the adhesive so that it is no longer tacky.

In practicing the invention shown in FIG. 5, it may be desirable to first apply or position one or more label templates at step 125. The label templates will have the general size and shape of the label segments or sheets that may be subsequently positioned on the web, but typically will not carry a final image or graphics that will be used in the preparation of the label intermediate web assembly that is the label templates are blank. It should, however, be understood that use of the label templates is not necessary and the process may simply begin with the placing of label segments or sheets that carry the final design or indicia that is to be produced in the present job or order. The use of such templates may only facilitate registration and alignment of the label segments on the web.

In practicing the present invention and to facilitate start up of the operation, the invention may be practiced by using a series of label ribbon templates. Each of these templates will be substantially equivalent in size and dimension to that of the prime label segments and will be used to ensure placement of the ribbons or segments on the web will be accurate.

Continuing with the discussion of the process depicted by the block diagram in FIG. 5, a series of prime label segments or sheets is supplied to a placing mechanism, which is subsequently described in reference to a later drawing, at step 130. The label segments will typically be of a uniform size and shape so that the placing mechanism may readily place the segments on the web, however, different sized and shaped segments, and even odd shaped segments (geometric, animate, inanimate shapes) may also be provided and placed on the web using the process of this invention. For example the label segments may include quadrate, animate or inanimate shapes that are placed in the placer mechanism in an order that they are intended to appear, e.g. quadrate, animate, inanimate and then repeating. In this way, customized label webs can be created and tailored to the individual needs of the end user.

The label segments are placed individually on the continuous web at step 140. Preferably, the placement of the label segments will permit a slight overlap of the segments on one another, so that a label web having an intermittent lamination is created. That is, the label segments when appearing in this overlapping arrangement will not be fully adhered or attached to the web. It should, however, be understood that no overlap may occur and the label segments may substantially abut one another or there may be a space between the segments or a combination of the foregoing may occur. That is, there may be some label segments that overlap, some segments that abut one another and some segments that are spaced from one another. In practicing the invention, the area occupied by the portion of the label segment that will become prime label intermediate will preferably be fully adhered to the web.

Optionally, the prime label intermediates may be connected to one another through use of a tape or string which may be applied at step 141 so that when the matrix is stripped away during a later processing step, the labels remain adhered to the web and are not inadvertently separated by the matrix removal. Where such tapes or strings are used, the tape or string would then be snapped or broken when the label is removed from the web prior to application to the article or package. Alternatively, the string may remain with the matrix and be stripped away.

Once the prime label segments are placed on the web, the web may be advanced to a die cutting station at step 145 where a cut will be made so that the prime label may be removed from any matrix or extra material when the prime label is ready to be applied to a container.

Down stream from step 140, the placing of the individual label segments on the web several optional operations may be performed. These include steps 146 the stripping off of the matrix, 147 application of a coating, 148 providing additional variable or personalized imaging and 149 over laminating. Any combinations of these steps may be practiced or all of them may be used in producing a particular job or order.

As described previously, step 146 relates to the stripping of the matrix. The die cutting operation performed at 145 creates, a cut between the area to be utilized as a prime label and the surrounding material that was provided with the label segment or strip.

Step 147 provides for the application of a particular coating such as a varnish so that the prime label will appear to have a glossy finish, a curable costing so that pseudo embossments may be created or other coatings to treatments that may be desirable in creating a particular configuration of a product.

As mentioned previously, one of the many potential benefits of the present invention is the ability to add additional variable or personalized printing or imaging in line and this is accomplished at step 148. Through use of this step, the manufacturer can provide additional text, graphics and other indicia to help highlight particular features of the product or service to which the prime label has been applied.

The final optional step mentioned above includes over laminating which is performed at step 149. In this step, plastic films can be applied over the top of the web so that cards having prime label type graphics can be produced by laminating a plastic film to the web.

The pressure sensitive prime label intermediate web assembly after processing through the above-mentioned steps and potentially one or more optional steps is collected at step 150. This step may include the winding of the web into a roll so that the web of labels can be taken to an application site where individual labels may be removed from the web, such as by an automatic applicator and then applied to packages or containers.

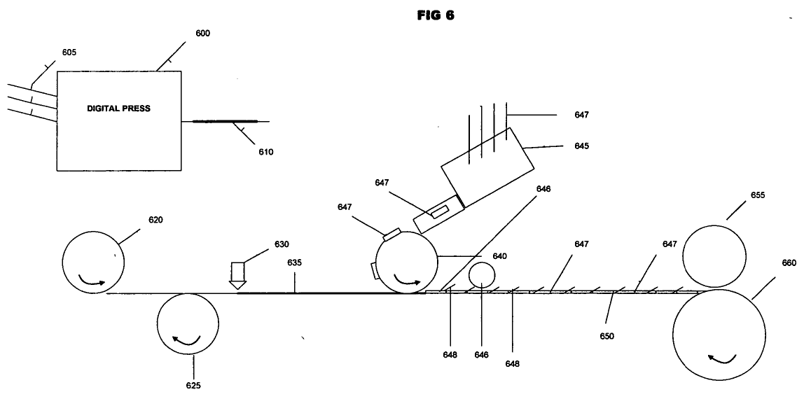

FIG. 6 provides a schematic representation of the apparatus used to carry out the present invention. Reference numeral 600 depicts a digital, sheet fed press such as Indigo® available from Hewlett Packard Company of Palo Alto, Calif. or Karat available from KBA of Williston, Vt. The press is provided with blank sheet stock 605 and then produces an image on the stock 610, depicted by a darkened area in the drawings which is then cut into individual label segments as described above. The individual segments are then loaded into a placer or insertion device such as a Maverick® available from InLine Automation of Minneapolis, Minn. as will be described herein.

The schematic of FIG. 6 shows a continuous carrier web depicted by reference numeral 620 which is supplied from a roll and is advanced to a coating area in a machine direction “A” by machine means such as rollers, belts and the like represented by numeral 625. The web 620 and is passed beneath an adhesive coating station 630 such as a slot coater, screen coater or other suitable means that can apply a pattern of adhesive to the web. The pattern of adhesive will generally only be the width of the label segments that are to be applied to the web.

The adhesive coated web 635 is then passed to a cylinder 640, e.g. vacuum, which is mounted beneath an insertion unit 645. Each of the pre-printed label segments 647 is passed by the inserter to the cylinder 640 and rotates around with the cylinder until it is placed on the adhesive coated web 635. The sheets 647 are placed serially and sequentially on the web so that the indicia and graphics are preferably visible. It should be understood that the graphics side may be placed face down so that they would be visible through a container, such as a glass bottle when the label was applied or alternatively, graphics may be applied on both faces of the label. As previously described, the label segments may preferably be placed in a slight overlapping relationship, slightly abutting or spaced from one another or a combination of the foregoing.

The label segments 647 may be temporarily joined to one another by tape strips or strings represented by numeral 648 so that when the matrix is stripped away, the tape strips will aid in holding the prime label intermediates in position and the prime labels will not be removed. The tape strips 648 are supplied from a roll 646 or other suitable application means.

Once the label segments have been placed on the web, the web may be advanced through additional stations, such as die cutting, 655 or coating, printing, over laminating, etc. and once the processing is completed, the intermediate web 650 is then collected such as by rewinding 660.

The label roll may then be removed to a use or application location where the individual prime labels are removed from the web and placed on containers or packages such as by a high speed label applicator.

The press speed runs at least at approximately about 50 feet per minute, more preferably between about 75 and 150 feet per minute and still more preferably at around about 200 feet per minute.

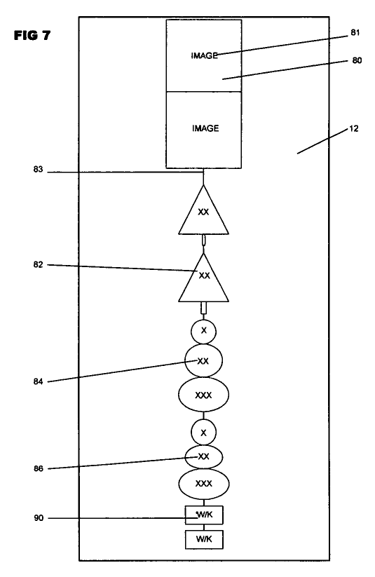

Turning now to FIG. 7 of the present invention, the carrier web 12 is shown with a number of prime labels which have had the matrix removed from around the area of the segment that is to make up the prime label. A series of prime label intermediates is shown which provides the variety of uses that can be made through use of the present invention. Prime label intermediate 80 is a substantially quadrate section having variable indicia 81 applied, intermediate 82 is a triangular prime label intermediate and label intermediate 82 and 81 are shown connected to one another through use of a tape or string referenced by numeral 83. It should be appreciated that the tape or string 83 may not be necessary. The string or strip can be removed with the matrix.

A variety of other prime label intermediates are also shown on the web, including 84 and 86 shown as snowmen and 90 quadrate labels. Each of the labels are shown connected to one another through the use of tape strips or strings 83. While the FIGURE provides a variety of different label configurations, it will be understood that these label configuration can be created either trough use of various die cuts or more preferably, but inserting into the placer mechanism label segments or ribbons having different configurations. In addition, the prime label intermediates may be inserted into the placer mechanism in a previously die cut arrangement.

Through use of the present invention, a vast array of identifiers, e.g. labels, tags, cards, plates, etc. can be placed on an adhesive coated web and then collected for later use, thereby creating a versatile pressure sensitive intermediate web assembly. Through the use of the foregoing process a manufacturer may create innumerable high quality graphics, illustrations and variable and personalized text and indicia to create a greater impact on the potential consumer or end user. The foregoing process has a number of benefits over conventional technologies in that the process can occur at roughly equivalent press speeds and may be handled by conventional label applicators.

The present invention further fulfills the need of the small to medium range market for prime labels, those quantities typically between 100 and 1,000,000 without requiring the payment of substantial premiums as may be necessary to offset the costs associated with traditional processes such as flexographic technology.

It will thus be seen according to the present invention a highly advantageous prime label assembly and method of manufacturing has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A method of producing a continuous label laminate assembly, comprising the steps of;
advancing a continuous web, said web have first and second longitudinally extending sides, first and second faces and a release coating provided on at least a portion of said first face and between the first and second longitudinally extending sides;
applying a pattern of adhesive on said first face over a portion of said release coating;
producing a plurality of discrete label ribbons intermediates from a pre-printed sheet, with each of said intermediates having at least one prime label portion having printing or imaging thereon;
placing each of said label ribbon intermediates sequentially on said continuous web over said adhesive and between said longitudinally extending sides of said continuous web such that said label ribbons are free of connection from one another;
advancing said continuous web with said plurality of discrete label ribbon intermediates adhered thereto; and
collecting said continuous web with said plurality of discrete label ribbon intermediates in a roll.

2. A method as recited in claim 1, wherein said plurality of label ribbon intermediates are placed in an edge to edge arrangement.

3. A method as recited in claim 1, including an additional step of die cutting each of said label ribbon intermediates after the step of placing said label ribbon intermediates on said continuous web.

4. A method as recited in claim 1, including a further step of applying a synthetic material over at least one of said plurality of discrete label ribbon intermediates after the step of placing said label ribbon intermediates on said continuous web.

5. A method as recited in claim 1, including a further step of printing or imaging variable indicia on said label ribbon intermediates after the step of placing said label ribbon intermediates on said continuous web.

6. A method as recited in claim 1, including a further step of placing a tape strip or string to connect said prime label portions of said successive label ribbon intermediates together after the step of placing said label ribbon intermediates on said continuous web.

7. A method as recited in claim 1, including a further step of die cutting said prime label portion in a shape selected from a group including geometric, animate, inanimate and combinations thereof.

8. A method of producing a continuous prime label laminate assembly, comprising the steps of;
advancing a continuous web, said web having first and second longitudinally extending sides, first and second faces and a release coating provided on at least a portion of said first face and between said first and second longitudinally extending sides;
applying a pattern of adhesive to said first face over said release coating on said continuous web;
placing sequentially a plurality of previously prepared discrete label ribbons intermediates substantially in an end to end arrangement on said continuous web over said adhesive with each of said intermediates having printing or imaging thereon in an area of a prime label portion and said label ribbon intermediates having been removed from a larger pre-printed sheet;
cutting each of said discrete label intermediates to form individual prime label portions;
removing a matrix from around each of said prime label portions; and
collecting said continuous web with said prime label portions in a roll format.

9. A method as recited in claim 8, wherein said printing or imaging is distinct on each of said label ribbon intermediates.

10. A method as recited in claim 8, including a further step of applying variable printing or imaging to said prime label portions prior to the step of cutting said discrete label intermediates.

11. A method as recited in claim 8, including a further step of applying a strip of tape or string between each of said prime label portions to temporarily connect said label portions together prior to the step of collecting the continuous web with said prime label portions thereon in a roll.

12. A method of creating a prime label intermediate pressure sensitive web, comprising the steps of;
providing a continuous web of material having first and second faces and first and second longitudinally extending sides and a release coating provided between said first and second longitudinally extending sides;
advancing said continuous web in a machine direction to a first station at least at a machine speed of at least about 50 feet per minute;
applying a pattern of adhesive in said machine direction to said first face of said continuous web over said release coating;
supplying a series of previously prepared prime label segments from a pre-printed sheet having a larger dimension than each of said prime label segments, with each segment having at least one prime label intermediate portion having a graphical depiction;
placing, serially each of said prime label segments over said pattern of adhesive in said machine direction such that each of said prime label segments are positioned in at least a substantial edge to edge configuration and are adhered to said web; and
advancing said continuous web with said prime label segments disposed thereon in a machine direction to a collection point to create a continuous web having a series of repeating prime label segments.

13. A method of creating a prime label intermediate pressure sensitive web, as recited in claim 12, including a further step of die cutting said continuous web with said prime label segments to create individual prime labels from said prime label intermediate portions after the step of placing said prime label segments.

14. A method of creating a prime label intermediate pressure sensitive web, as recited in claim 12, including a further step winding said continuous web with said prime label segments thereon into a roll at said collection point.

15. A method of creating a prime label intermediate pressure sensitive web, as recited in claim 12, wherein each of said prime label intermediate portions is provided with graphical depictions of more than about 150 lines per inch.

16. A method of creating a prime label intermediate pressure sensitive web, as recited in claim 12, wherein said prime label segments are provided in a substantial edge to edge configuration in which a portion one prime label segment overlaps a portion of a successive prime label segment in a machine direction to create a pressure sensitive laminate web assembly having intermittent laminations.

17. A method of creating a prime label intermediate pressure sensitive web, as recited in claim 12, including a further step of initially placing prime label templates on said continuous web prior to the step of placing said previously prepared prime label segments on said web to confirm registration of placements.

18. A method of creating a prime label intermediate pressure sensitive web, as recited in claim 12, including a further step of printing or imaging each of said prime labels segments subsequent to the step of supplying said previously prepared prime label segments.

19. A method of creating a prime label intermediate pressure sensitive web, as recited in claim 12, said previously prepared prime labels segments are selected from a group including printed or imaged prime label segments, coated prime label segments, embossed or pseudo embossed prime label segments, personalized prime label segments and combinations thereof.

20. A method of creating a prime label intermediate pressure sensitive web as recited in claim 12, including an additional step of placing a strip of tape or string between successive prime label intermediates to hold said prime label intermediates on said web.
